(19) United States
(12) Patent Application Publication
(10) Pub. No.: US 2022/0148035 A1
(43) Pub. Date: May 12, 2022

(54) PREDICTING UTILIZATION OF AUTONOMOUS VEHICLE AND MANAGING TRAVEL DEMAND

(71) Applicant: International Business Machines Corporation, Armonk, NY (US)

(72) Inventors: Shikhar Kwatra, San Jose, CA (US); Jeremy R. Fox, Georgetown, TX (US); Gregory J. Boss, Saginaw, MI (US); Sarbajit K. Rakshit, Kolkata (IN)

(21) Appl. No.: 17/096,663

(22) Filed: Nov. 12, 2020

(51) Int. Cl. G06Q 30/02; G06N 20/00

(52) U.S. Cl. CPC G06Q 30/0261; G06Q 30/0265; G06Q 30/0267; G06N 20/00

(57) ABSTRACT

An approach for predicting utilization of autonomous vehicles for a specified time range and optimizing the utilization of the autonomous vehicles is disclosed. The approach leverages machine learning to send targeted advertising to potential passengers. The approach determines which potential passengers will have a high likelihood of accepting a targeted request. Additionally, the approach will further optimize the autonomous vehicles utilization by using multiple autonomous vehicles for a single passenger.

### BACKGROUND

The present invention relates generally to transportation, and more particularly to managing autonomous vehicles in a rideshare infrastructure.

Ride sharing works by assigning passengers to a driver so that the passengers can get to their predetermined destination, often within a metropolitan area. Potential passengers initiate a request via their smartphones by inputting their destination. A driver within the vicinity of the passenger receives the request and chooses to accept based on first in, first out (FIFO) order. The network service directs a passenger to a predetermined location once a driver has committed to selecting the passenger. Once the ride is complete, the network system automatically deducts the fee from a previously stored payment card in the passenger's profile. The social network aspect helps establish a trust and accountability between driver and passenger based on a feedback system. For example, a passenger can rate the driver based on promptness, courtesy, and cleanliness. In addition, a driver can rate the passenger on similar criteria to ensure a smooth and safe transaction.

### SUMMARY

Aspects of the present invention disclose a computer-implemented method, a computer system and computer program product for optimizing the use of autonomous vehicle. The computer implemented method may be implemented by one or more computer processors and may include: determining a status of a first autonomous vehicle, wherein the status is not in use; detecting one or more users in a vicinity of the first autonomous vehicle; determining a first travel destination of one or more of users; and based on the first travel destination of a first user from the one or more users, providing a first advertisement to the first user of the one or more users for a ride in the first autonomous vehicle.

According to another embodiment of the present invention, there is provided a computer system. The computer system comprises a processing unit; and a memory coupled to the processing unit and storing instructions thereon. The instructions, when executed by the processing unit, perform acts of the computer-implemented method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the computer-implemented method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a high level overview of the transportation environment, designated as 100, in accordance with an embodiment of the present invention;

FIG. 2 is a functional block diagram illustrating the subcomponents of transportation component 111, in accordance with an embodiment of the present invention;

FIG. 3 is a high-level flowchart illustrating the operation of transportation component 111, designated as 300, in accordance with an embodiment of the present invention; and

FIG. 4 depicts a block diagram, designated as 400, of components of a server computer capable of executing the transportation component 111 within the transportation environment 100, in accordance with an embodiment of the present invention.

### DETAILED DESCRIPTION

Embodiments of the present invention provides an approach for predicting utilization of autonomous vehicles for a specified time range and optimize the utilization by using targeted advertisement directed at potential passengers. The approach leverages machine learning to forecast and predict customer usage pattern based on various data (e.g., user location, vehicle location, IoT sensors, social media, mood of users, etc.). Based on the predicted duration of idle time of one or more autonomous vehicles in different geographical locations, the present embodiment will deliver appropriate travel offers to potential customers to increase the utilization of the autonomous vehicles. For example, in a scenario, during one afternoon, an autonomous vehicle remains idle for a long time, so the embodiment will attempt to shift some of the travel demands during that time. A potential customer that usually travels around this time from work to home is sent an offer (i.e., customized advertisement to his phone) to travel now (30 mins early) at a 50% discount. The potential customer can choose to be picked up curbside and accept the discounted offer.

In another example, the autonomous vehicle system has predicted an idle time for a particular location, set of vehicles and duration. In this case, the centralized autonomous vehicle system has analyzed various sources of data like social network feed (sharing location, photos etc.), mobile phone tracking data, camera feed analysis, historical data, etc., and has identified that many people are standing in a particular area. The system also identifies the activities they are engaged in (e.g., walking on the sidewalk). Thus, there is a chance that a travel offer shown to those people would be effective so the system displays it on a sign on the vehicle.

In yet another example, embodiment may observe three potential passengers on the street corner after a football game. Assuming, those potential passengers has opted in for privacy setting, embodiment can retrieve social media information, driving profile information, habits and propensity of the passengers (e.g., favorite food including restaurants, favorite sports/last outing to watch/play the sport, etc.). The social media posting has indicated that they want to grab a bite at their favorite restaurant to celebrate their team's victory. Thus, those passengers will be most likely using a ride-sharing service and would be receptive for targeted advertisement.

Other embodiments of the present invention may recognize one or more of the following facts, potential problems, potential scenarios, and/or potential areas for improvement with respect to the current state of the art: i) enables transportation companies (including ride-sharing platforms) to optimize the use of vehicles that would otherwise sit idle and ii) allow vehicles that would be poorly positioned to service a predicted customer demand.

Other embodiments, the system may involve multiple passengers (i.e., cohorts). For example, an autonomous vehicle, leveraging ride-sharing business, has identified a potential customer and their predicted travel destinations and times. The system then sends an offer to the potential customer that will benefit both parties. To further illustrate the above example, a use case is presented. Several potential customers are identified gathering at a movie theater through mobile phone tracking data or alternatively potential customer demand is anticipated to occur at the movie theater after a scheduled blockbuster movie ends which will introduce a higher demand in the area. So, based on predicted activities of the potential customer, appropriate travel offers will be sent to the potential customers. These offers can entice frequent movie patrons to travel to the movie theater in order to get the autonomous cars to the theater where demand is expected and to get customers exiting the theater to use their services with zero wait time.

Other embodiments, the system may involve optimal advertisement mode with vehicle booking app. For example, the mode of advertisement to the potential customer can be delivered via an autonomous vehicle booking app, sending text messages, displaying travel offers on the outside displays of vehicles, or displaying on billboards, etc. While delivering these travel offers, the autonomous vehicle ecosystem will attempt to identify possible events where the potential customer may be interested in traveling. To further illustrate the above example, a use case is presented. A travel offer can be displayed on the display screen within the vehicle, so that nearby people can view the offer or plan for a journey. Alternatively, a current customer can view an offer at the end of a ride that can extend an additional service such as delivering items the customer selects on a retail web page that was browsed during the trip or after the customer visits a brick and mortar store.

Other embodiments, the system may involve optimal advertisement mode with vehicle booking app while the passengers are on a ride. For example, the system will also attempt to optimize travel from source to destination when multiple passengers are present that are going to slightly different destinations. The system will do this by coordinating two autonomous vehicles to split the ride of a single passenger in order to optimize vehicle placement. To further illustrate the above example, a use case is presented. In this scenario, two passengers 1 and 2 are riding in one vehicle to two slightly different destinations (A and B) and are midway through of the trip. The current route plan of the autonomous vehicle is to deliver passenger 1 to destination A and then continue to bring passenger 2 to destination B. A third passenger (passenger 3) located at position B generally travels to position C and a second autonomous vehicle is sitting idle at the current vehicle's location. The system then asks passenger 2 if they are willing to transfer to another autonomous vehicle for a 5% discount on the fare, which will also get them to their destination 5 minutes sooner. The passenger accepts the offer and the two autonomous vehicles coordinate a transfer stop: passenger 2 gets out and moves to the second vehicle and continues to destination B while the first vehicle continues to location A; mid route of the travel, vehicle B sends an offer to passenger 3 to travel to location C, he/she accepts it and the second vehicle goes directly to B where passenger 2 is dropped off and passenger 3 enters. The system becomes more efficient by implementing this vehicle splitting technique.

Other embodiments, the system may involve with advertisement through/with ride-sharing vehicle infrastructure. For example, embodiment may detect an idle (i.e., not in use) ride sharing vehicle (e.g., autonomous or non-autonomous) and detect a plurality of potential passengers within the vicinity of the ride-sharing vehicle. Embodiment would ascertain the destination of travel of the potential passengers by inquiring the passengers directly or based on non-explicit queues (e.g., one passenger may yell to the group, “Let's go the movies . . . ” social media status, such as, “We're going to the movies!” etc.). After determining the final destination of the potential passengers, embodiment can create and deliver targeted advertisement to the group of passengers on the ride-sharing vehicle.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

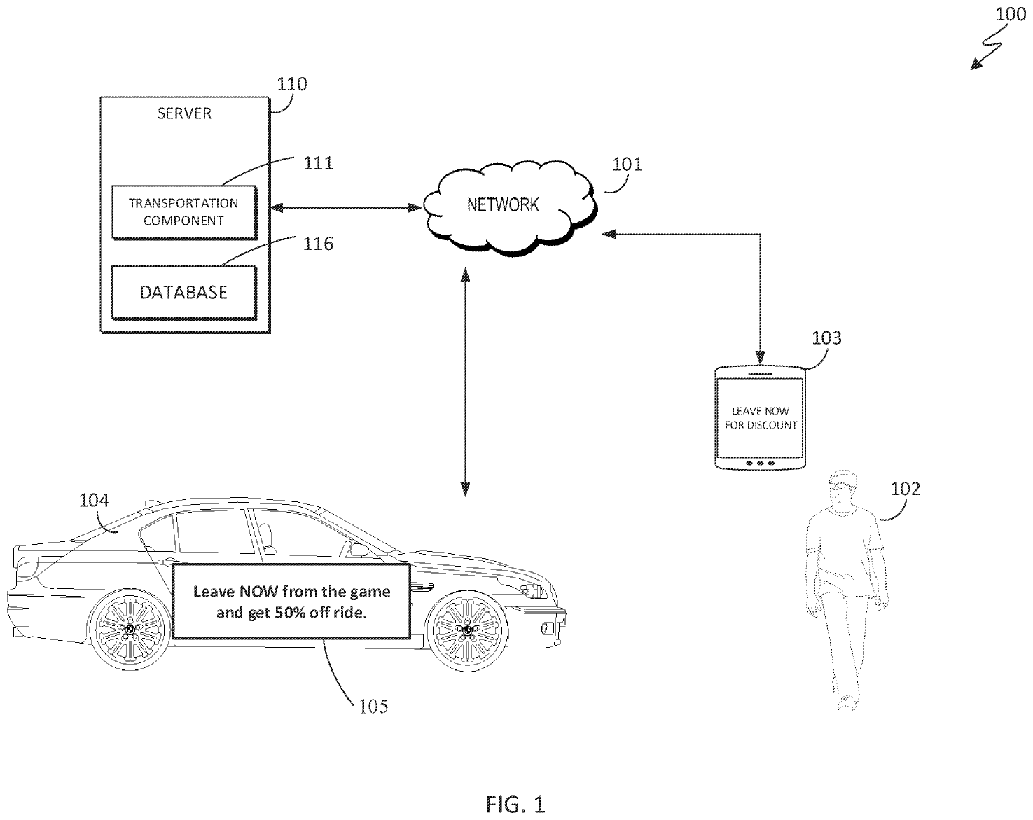

FIG. 1 is a functional block diagram illustrating a transportation environment 100 in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Transportation environment 100 includes network 101, passengers 102, Smart devices 103, vehicles 104, vehicle display 105 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110 , Smart devices 103, passengers 102 and other computing devices (not shown) within transportation environment 100. It is noted that other computing devices can include, but is not limited to, passengers 102 and any electromechanical devices capable of carrying out a series of computing instructions.

Passengers 102 can be one or more users (i.e., passengers) in need of traveling from one location to another.

Smart devices 103 can be any smart device (e.g., wearable smart devices, smart phones, wireless camera, etc.) used by passengers to communicate with AVs. Smart devices can receive custom advertisements from AVs. Furthermore, Smart devices 103 (e.g., thermal sensors/imaging, heart rate monitor and microphones) can be used to determine the cognitive state of the passengers.

Vehicles 104 can be any vehicle used for transportation (e.g., sedan, bus, truck, etc.) of passengers. Vehicles 104 can be equipped with an array of sensors (e.g., cameras, microphone, etc.) to detect voice and passengers. Furthermore, vehicles 104 can be equipped with vehicle display 105.

Vehicle display 105 are devices capable of displaying still or moving text, images, and video advertising content using any of several existing technologies (e.g., LCD, LED, projection, hologram, etc.). Vehicle display 105 can display content on screens mounted on to any exterior surfaces not obstructed by parts of the vehicle.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any other programmable electronic device capable of communicating other computing devices (not shown) within transportation environment 100 via network 101. In another embodiment, server 110 represents a computing system utilizing clustered computers and components (e.g., database server computers, application server computers, etc.) that act as a single pool of seamless resources when accessed within transportation environment 100.

Embodiment of the present invention can reside on server 110. Server 110 includes transportation component 111 and database 116.

Transportation component 111 provides the capability of predicting utilization of autonomous vehicles for a specified time range and optimize utilization by using targeted advertisement to potential passengers.

Database 116 is a repository for data used by transportation component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within transportation environment 100, provided that transportation component 111 has access to database 116. Database 116 may store information associated with, but is not limited to, knowledge corpus, i) historical travel pattern for a city, ii) historical travel pattern for one passenger, iii) historical travel pattern for multiple passenger in the city/household/group/network and iv) historical pattern of passenger's cognitive moods.

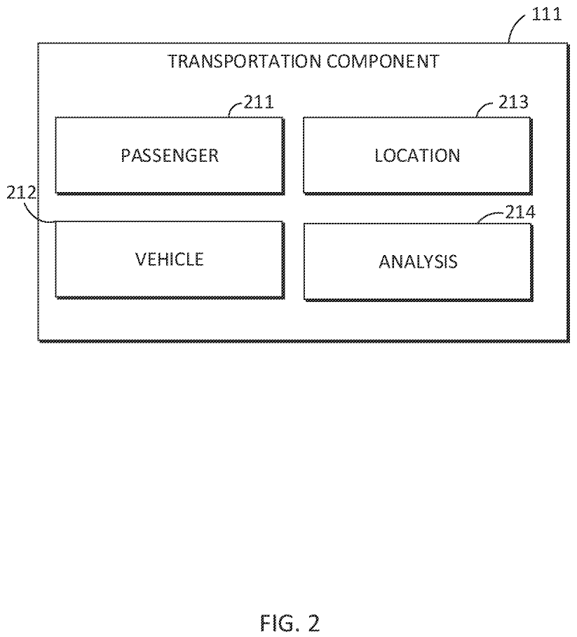

FIG. 2 is a functional block diagram illustrating transportation component 111 in accordance with an embodiment of the present invention. In the depicted embodiment, transportation component 111 includes passenger component 211, vehicle component 212, location component 213 and analysis component 214.

As is further described herein below, passenger component 211 of the present invention provides the capability of communicating with, but it is not limited to, social network, mobile phone metadata and Smart devices 103 (e.g., IoT cameras, wearable smartwatch and microphones, etc.) to determine a passenger travel profile. A passenger profile is a travel history profile of passenger based on historical data (e.g., ridesharing trips, social media posting, etc.). It is noted that passenger component 211 can communicate (i.e., send and retrieve) with database 116.

As is further described herein below, vehicle component 212 of the present invention provides the capability of retrieving a list of AV and characteristics of the AV. The characteristics of the AV can include, but it is not limited to, passenger carrying capacity, range of AV, cargo capacity, type and number of digital advertisement signs on the AV and amenities of AV. In addition, vehicle component 212 can receive data from AV such as, i) active versus non-active (i.e., has passenger or not), ii) if active, number of passenger carrying and iii) status of current cargo capacity if the AV status is active. It is noted that vehicle component 212 can integrate with existing ride-sharing platform/infrastructure.

As is further described herein below, location component 213 of the present invention provides the capability of determining the location of all (e.g., active and non-active) AVs within the fleet, the location of potential passengers and location of active AV (i.e., transporting passengers). All AVs are equipped with GPS tracking technology. Depending on privacy permission/setting (i.e., passenger's permission on location) of the passengers, location component 213 can determine the location of i) potential passengers and ii) current passengers (i.e., on a trip) based on the following, i) object detection of cameras built-into the AV, ii) wearable smart devices of passengers, iii) smartphone's location.

In addition, location component 213 can instruct AVs to a designated location and send customized advertisements to AVs. It is noted that location component 213 can integrate with existing ride-sharing platform/infrastructure.

As is further described herein below, analysis component 214 of the present invention provides the capability of determining, by leveraging AI, i) where to send AVs, ii) creating content custom advertisements and iii) where and whom to send the created custom advertisement based on several travel factors. It is noted that analysis component 214 can be extended for use with existing ride-sharing platform/infrastructure. These travel factors are based on the data received from, but it is not limited to, passenger component 211, vehicle component 212, traffic servers, weather servers, etc. There are several principles, such as supply and demand, that analysis component 214 can leverage via machine learning to predict and forecast demands for AV. The travel factors can include the following, i) travel need analysis, ii) idle time compute, iii) IoT sensor feeds and crowdsourced data, iv) travel pattern evaluation, v) user device data capture, vi) data share enablement and vii) potential customer identification.

The factor, travel need analysis, means that the data related to the autonomous vehicle ecosystem will historically be collected that includes the travel need of different passengers, considering date, timing, location and weather etc. The factor, idle time compute, means that, the historical data can indicate the spread of travel demand in different time frame, location, weather etc. and the time range where the travel demand is less, or more idle time for the autonomous vehicles. The factor, IoT sensor feeds and crowdsourced data, means that the centralized autonomous vehicle ecosystem will be collecting various sources of information on real-time basis, to identify if any potential customers are present in the roadside or walking whom the advertisements can be displayed. The factor, travel pattern evaluation, means that, using historical data analysis, the autonomous vehicle ecosystem will identify different travelers travel pattern, like timing of travel, where they go, how long they spend time, based on booking of the autonomous vehicle data. The factor, user device data capture, means that mobile phone tracking can also be used for identifying the location, direction of travel and etc. of different potential travelers. For example, as advertisement from the autonomous vehicles are for a win-win situation, both for travelers and autonomous vehicle service providers, so the passengers will be volunteering to share specific mobility related data to get appropriate advertisements related to travel. The factor, data share enablement, means that mobile phone data, or online activity data can also be shared by the volunteer users to get the appropriate advertisements. The centralized autonomous vehicle ecosystem can identify the social network contribution of different users. The factor, potential customer identification, means that the previously sources of data related travel factors (e.g., factors, i to iv) will be analyzed to identify the potential customers and their possible activities in different time frame.

Additionally, there are advertisement factors used to create custom advertisement which can include travel factors and the following, i) parameters evaluation in feedback mechanism, ii) dynamic advertisement enablement, iii) advertisement delivery mode and iv) event capture plan. The advertisement factor, parameters evaluation in feedback mechanism, means that, the autonomous vehicle ecosystem can identify the potential customers can be targeted during any predicted idle time. Based on the type of activities are being performed, and location of the target travelers, the appropriate advertisements will be displayed. The advertisement factor, dynamic advertisement enablement, means that, while delivering the advertisement of travel during the idle time, the autonomous vehicle ecosystem can explain how the potential travelers will be benefitted, like “Now you can travel to XYZ park with 50% travel cost”, “if you travel now then you will get 20% off in the travel cost, or 20% off in the movie ticket”, or “One street show is being going on in location X, you can travel now with 20% discounted price.” The advertisement factor, advertisement delivery mode, means that the mode of delivery of the advertisement can be displayed on the body of the vehicle, or in the form of text message on the vehicle booking app, or displayed on an online shopping portal, social network page, etc. The advertisement factor, event capture plan, means that, while delivering advertisement, the autonomous vehicle ecosystem can identify various events where the user might be interested, and can travel with autonomous vehicle.

In an alternative embodiment, analysis component 214 can include the cognitive state of the user as an additional factor to understand the travel pattern of the user. The method of understanding the user cognitive state and historical patterns with respect to idle times and travel offers, with a certain confidence level C further comprises, i) analyzing real-time interaction/engagement pattern/sequence, facial expression using inputs received from the front camera of the user smartphone or nearby camera, etc., ii) analyzing a plurality of user activities that may include conversations and control of certain objects in the vicinity (e.g., AC, Remote controls, Gas, Thermostat, entities in space etc.), iii) source and destination along with wait times for said profiles or plurality of users and previous idle time factors and iv) dynamically clustering entity profiles by machine learning mechanism.

The input parameters that are fed inside the system in order to understand the user's cognitive state of the user with respect to the applications being used are as follows, i) mood and cognitive state of the user (i.e., monitored using wearables/cameras and related devices), ii) time of the day, iii) user's schedule/Calendar activity, iv) conversation monitoring, v) geo-spatial metrics, and vi) object monitoring. A multi-layer neural network model or supervised machine-learning model, for instance, logistic regression model with regularization can be used in order to understand and classify the relative state of the user and the activity of the user in conjunction with the entities in space.

By way of an implementation example of an alternative embodiment for analysis component 214, an algorithmic approach (i.e., clustering entities based on profiles and travel patterns, inclusive of idle times) may include the following steps (pseudo-programming code):
For each User Ui in the current detected list of users U
Get Ui characteristics: tone t, personality p, language expression l, facial gestures f, body gesture/action b, travel profile tp as Ui(t, p, l, g, b, tp)
Ui (t, p, l, g, b) is analyzed to determine cognitive state and behavior Ui(cs, be)
If Ui(cs, be) surpass an initial threshold time t_w, a monitoring session is started for Ui and cohorts.
For each history record Ui_Hi in Ui_H, If Ui_Hi contains an old user cognitive state behavior Ui(cs, be) that triggered a feedback to the system that is similar to the current Ui(cs, be), then a cluster monitoring session is started for Ui and cohorts.
Continuously monitor Ui and cohorts. Get Ui characteristics: tone t, personality p, language expression l, facial gestures f, body gesture/action b, travel profile tp as Ui(t, p, l, g, b, tp).
Change configuration on components.
Measure Ui reactions to change in travel patterns and idle times including distance between source and destination.
Each clustering action P_Ai contains a set of machine comprehensible actions, a duration, a prioritization, and a set of user cognitive states and behaviors based on said modification in travel patterns tpx: Ux(cs, be, tpx) for which the P_Ai is recommended.
The prioritization in the P_Ai is used to set the order of clustering action in which these minimize affectation to user usage.
P_Ai is selected according to the current Ui(cs, be, tpx) and priority P_Ai_p
After P_Ai execution duration, monitoring session continues
If Ui(cs, be) is below warning threshold for a configured amount of time, the monitoring
session is finished and recommendations are provided based on changing travel patterns
Save session in use history Ui_H for future reference and future recommendations.

In summary, analysis component 214 can leverage, via machine learning, to predict and forecast demands for AV and deliver custom advertisements to potential travelers based on, but it is not limited to, travel factors, advertisement factors, cognitive moods of passengers, weather forecast and traffic patterns.

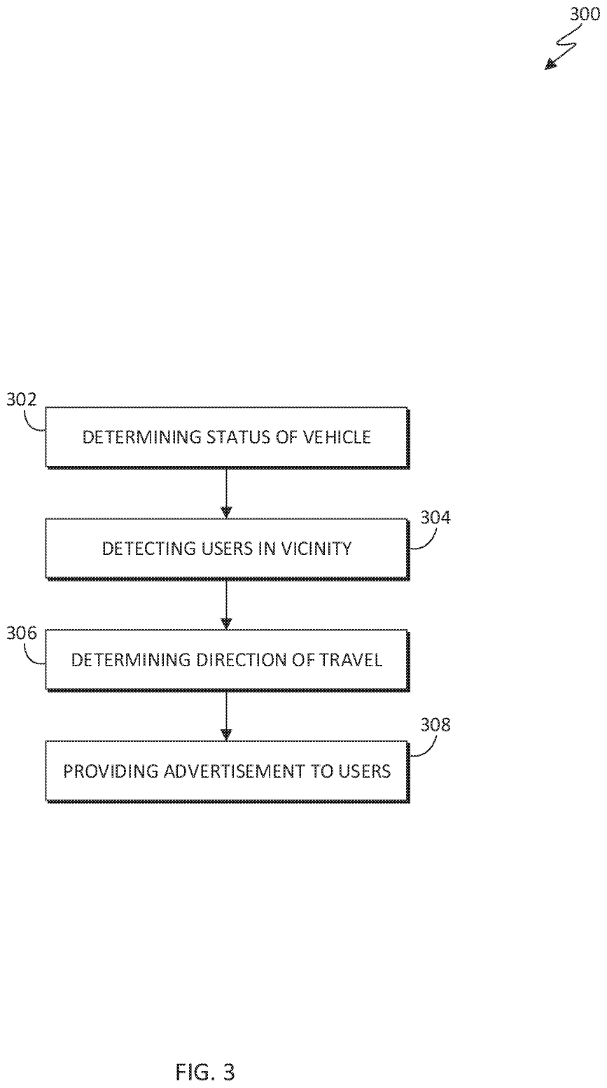

FIG. 3 is a flowchart illustrating the operation of transportation component 111, designated as 300, in accordance with another embodiment of the present invention.

Transportation component 111 determines the status of the vehicle (step 302). In an embodiment, transportation component 111, through vehicle component 212 and location component 213, determines the location of idle AVs. For example, user1 and user2 were at the mall and is now standing outside the mall entrance to determine their next destination. Transportation component 111 queries the available (i.e., non-active/idle) AVs near the mall building. There are two idle AVs (e.g., AV_1, AV_2), parked by the ride-share zone (i.e., designated for pickup-drop off for ride-share service) of the building.

Transportation component 111 detect users in the vicinity (step 304). In an embodiment, transportation component 111, through location component 213 and passenger component 211, detects users nearby of the AVs. Using the previous example, the camera sensors of AV_1 and AV_2 detect user1 and user2 nearby.

In an alternative embodiment, transportation component 111 can query the smart device (e.g., phone and wearable watch) of user1 and user2 to determine the location of the users.

Transportation component 111 determines the direction of travel (step 306). In an embodiment, transportation component 111, through analysis component 214, can determine the desired destination of the users. Using the previous example, user1 and user2 was lamenting on where to go next after the mall since they are unsure if they want to eat dinner first or go to a pub. Both users post a message on social media asking if there anything fun to do today. A few friends respond by a post, stating that there is a party at user3's house (across town). Assuming that all users have permission setting to allow transportation component 111 access to social media posting and other personal data (e.g., heart rate monitor, etc.), analysis component 214 can determine that user1 and user2 wants to go to user3's party.

In an alternative embodiment, transportation component 111 may directly send an inquiry to the smart device (e.g., phones, wearable watch, etc.) belonging to the user, asking where the user would like to travel, (i.e., “Where would you like to go today?”). On the other hand, transportation component 111 may display the previous message on vehicle display 105 (located on the display of AV_1 and AV_2), where the message can be seen by user1 and user2.

Transportation component 111 provides advertisement to the users (step 308). In an embodiment, transportation component 111, through analysis component 214, sends a custom advertisement to the users. Using the previous example, transportation component 111 sends a custom advertisement message (i.e., “50% off on a trip across town if you act now !!!”) to user1 and user2's phone and to vehicle display 105 of AV _1 and AV_2.

In alternative embodiment, another use case is presented. Referring to FIG. 1, a group of friends (i.e., passengers 102) is at a football game, cheering for their favorite team, ABC. The ABC team is losing to their in-state rival, XYZ, by a wide margin with one quarter left to go in the game. The group of friends are feeling dejected by the game's progression and they would rather be somewhere else. The friends have been complaining on social media on the game status (i.e., “This game is terrible, my team will never come back at this rate . . . I wish I was at a pub to drown my sorrow . . . ”). Transportation component 111 can determine that the friends are potential passengers and sends a custom advertisement to smartphones of the group of friends. The advertisement reads, “Is your team losing badly? Do you want to get away? Leave now and get 60% off !!!” The group of friends picks a destination based on their depressed mood into the ride-sharing software application and promptly, an AV is waiting outside the parking lot of the football stadium (before the game concludes).

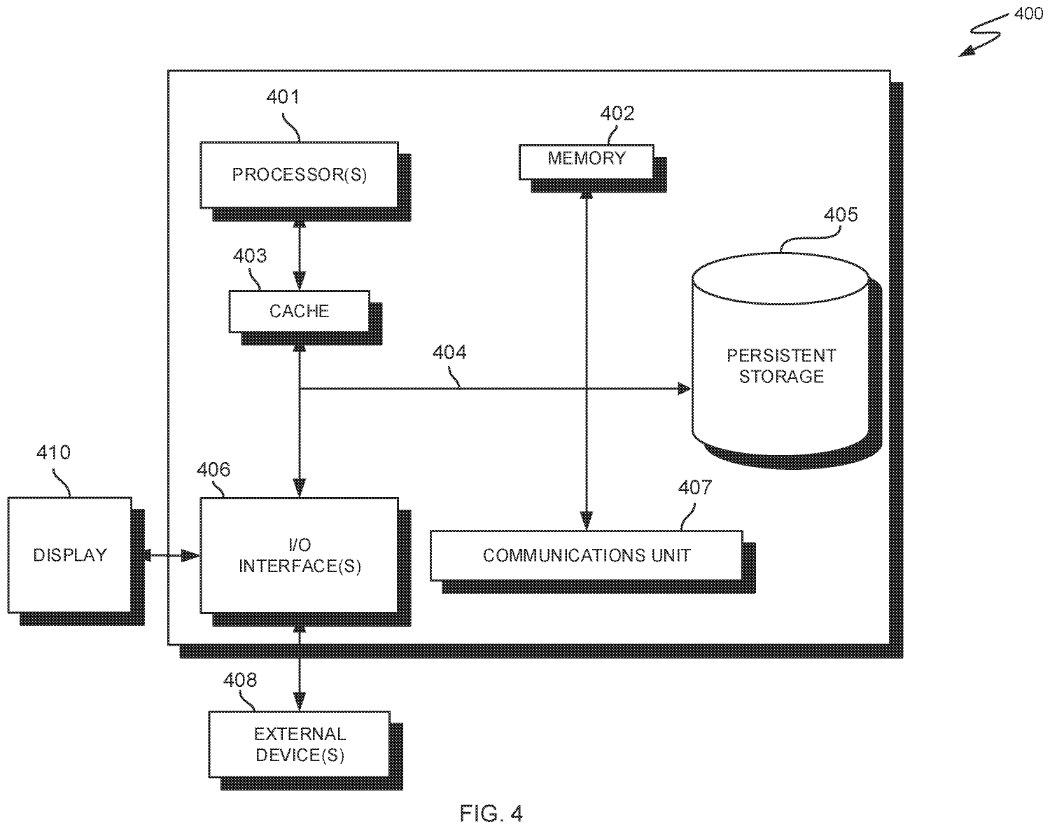

FIG. 4, designated as 400, depicts a block diagram of components of transportation component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data x10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Transportation component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., Transportation component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., Transportation component 111) used to practice embodiments of the present invention can be stored on such portable computer readable storage media and can be loaded onto persistent storage 405 via I/O interface(s) 406. I/O interface(s) 406 also connect to display 410.

Display 410 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method for providing advertisement to users of autonomous vehicle in a ride-sharing infrastructure, the computer-implemented method comprising:
determining whether a first autonomous vehicle is not carrying any users, wherein the first autonomous vehicle is part of a ride-sharing infrastructure;
In responsive to the first autonomous vehicle is not carrying any users, detecting the one or more users in a vicinity of the first autonomous vehicle;
determining a first travel destination of a first user of the one or more of users based on the selection of a mobile device belonging to the first user;
determining a second travel destination of a second user of the one or more of users based on the selection of a mobile device belonging to the first user;
providing a first advertisement to the first user of the one or more users;
accepting the selection of the first advertisement by the first user to be transported to the first destination;
carrying the first user and a second user in the first autonomous vehicle to the first travel destination and a second travel destination, respectively;
determining a second autonomous vehicle does not have any users, wherein the second autonomous vehicle is located at the first travel destination and the second autonomous vehicle is part of the ride-sharing infrastructure;
providing a second advertisement to the second user, wherein the second advertisement offers a discount for the second user to transfer from the first autonomous vehicle into the second autonomous vehicle at the first destination;
accepting the selection of the second advertisement by the second user to be transfer into the second autonomous vehicle at the first destination;
arriving at the first destination by the first autonomous vehicle, wherein the first and the second passenger departs the first autonomous vehicle, respectively; and
carrying the second user by the second autonomous vehicle to the second destination.

2. (canceled)

3. The computer-implemented method of claim 1, wherein detecting the one or more users in a vicinity of the first autonomous, further comprises:
using sensors equipped on the first autonomous vehicle to detect the one or more users; and
querying a smart device of the one or more users to determine a location of the one or more users.

4. The computer-implemented method of claim 1, wherein determining a first travel destination of the one or more of users, further comprises:
querying the one or more users via a smart device for the first travel destination.

5. The computer-implemented method of claim 1, wherein providing a first advertisement to the first user of the one or more users, further comprises:
sending the first advertisement via a smart device, wherein the first advertisement contains a discount to entice the first user to ride in the first autonomous vehicle.

6. (canceled)

7. The computer-implemented method of claim 1, further comprising:
detecting a third user located at the second travel destination but the third user is not requesting a trip;
determining a third travel destination of the third user based on travel history of the third user, providing a third advertisement to the third user, wherein the third advertisement offers a discount for the third user to travel from the second travel destination to the third travel destination; and
accepting by the third user for a ride in the second autonomous vehicle to the third travel destination after the second user has reached the second travel destination.

8. A computer program product for providing advertisement to users of autonomous vehicle in a ride-sharing infrastructure, the computer program product comprising:
one or more computer readable storage media and program instructions stored on the one or more computer readable storage media, the program instructions comprising:
program instructions to determine whether a first autonomous vehicle is not carrying any users, wherein the first autonomous vehicle is part of a ride-sharing infrastructure;
In responsive to the first autonomous vehicle is not carrying any users, program instructions to detect the one or more users in a vicinity of the first autonomous vehicle;
program instructions to determine a first travel destination of a first user of the one or more of users based on the selection of a smart device belonging to the first user;
program instructions to determine a second travel destination of a second user of the one or more of users based on the selection of a smart device belonging to the first user;
program instructions to provide a first advertisement to the first user of the one or more users;
program instructions to accept the selection of the first advertisement by the first user to be transported to the first destination;
program instructions to carry the first user and a second user in the first autonomous vehicle to the first travel destination and a second travel destination, respectively;
program instructions to determine a second autonomous vehicle does not have any users, wherein the second autonomous vehicle is located at the first travel destination and the second autonomous vehicle is part of the ride-sharing infrastructure;
program instructions to provide a second advertisement to the second user, wherein the second advertisement offers a discount for the second user to transfer from the first autonomous vehicle into the second autonomous vehicle at the first destination;
program instructions to accept the selection of the second advertisement by the second user to be transfer into the second autonomous vehicle at the first destination;
program instructions to arrive at the first destination by the first autonomous vehicle, wherein the first and the second passenger departs the first autonomous vehicle, respectively; and
program instructions to carry the second user by the second autonomous vehicle to the second destination.

9. (canceled)

10. The computer program product of claim 8, wherein program instructions to detect the one or more users in a vicinity of the first autonomous, further comprises:
using sensors equipped on the first autonomous vehicle to detect the one or more users; and
program instructions to query a smart device of the one or more users to determine a location of the one or more users.

11. The computer program product of claim 8, wherein program instructions to determine a first travel destination of the one or more of users, further comprises:
program instructions to query the one or more users via a smart device for the first travel destination.

12. The computer program product of claim 8, wherein program instructions to provide a first advertisement to the first user of the one or more users, further comprises:
program instructions to send the first advertisement via a smart device, wherein the first advertisement contains a discount to entice the first user to ride in the first autonomous vehicle.

13. (canceled)

14. The computer program product of claim 8, further comprising:
program instructions to detect a third user located at the second travel destination;
program instructions to determine a third travel destination of the third user, providing a third advertisement to the third user, wherein the third advertisement offers a discount for the third user to transfer from the first autonomous vehicle into the second autonomous vehicle; and
program instructions to accept the transfer by the third user for a ride in the second autonomous vehicle after the second user has reached the second travel destination.

15. A computer system for advertisement to users of autonomous vehicle in a ride-sharing infrastructure, the computer system comprising:
one or more computer processors;
one or more computer readable non-transitory storage media;
program instructions to determine whether a first autonomous vehicle is not carrying any users, wherein the first autonomous vehicle is part of a ride-sharing infrastructure;
In responsive to the first autonomous vehicle is not carrying any users, program instructions to detect the one or more users in a vicinity of the first autonomous vehicle;
program instructions to determine a first travel destination of a first user of the one or more of users based on the selection of a smart device belonging to the first user;
program instructions to determine a second travel destination of a second user of the one or more of users based on the selection of a smart device belonging to the first user;
program instructions to provide a first advertisement to the first user of the one or more users.
program instructions to accept the selection of the first advertisement by the first user to be transported to the first destination;
program instructions to carry the first user and a second user in the first autonomous vehicle to the first travel destination and a second travel destination, respectively;
program instructions to determine a second autonomous vehicle does not have any users, wherein the second autonomous vehicle is located at the first travel destination and the second autonomous vehicle is part of the ride-sharing infrastructure;
program instructions to provide a second advertisement to the second user, wherein the second advertisement offers a discount for the second user to transfer from the first autonomous vehicle into the second autonomous vehicle at the first destination;
program instructions to accept the selection of the second advertisement by the second user to be transfer into the second autonomous vehicle at the first destination;
program instructions to arrive at the first destination by the first autonomous vehicle, wherein the first and the second passenger departs the first autonomous vehicle, respectively; and
program instructions to carry the second user by the second autonomous vehicle to the second destination.

16. The computer system of claim 15, wherein program instructions to detect the one or more users in a vicinity of the first autonomous, further comprises:
using sensors equipped on the first autonomous vehicle to detect the one or more users; and
program instructions to query a smart device of the one or more users to determine the location of the one or more users.

17. The computer system of claim 15, wherein program instructions to determine a first travel destination of the one or more of users, further comprises:
program instructions to query the one or more users via a smart device on the first travel destination.

18. The computer system of claim 15, wherein program instructions to provide a first advertisement to the first user of the one or more users, further comprises:
program instructions to send the first advertisement via a smart device, wherein the first advertisement contains a discount to entice the first user to ride in the first autonomous vehicle.

19. (canceled)

20. The computer system of claim 15, further comprising:
program instructions to detect a third user located at the second travel destination;
program instructions to determine a third travel destination of the third user, providing a third advertisement to the third user, wherein the third advertisement offers a discount for the third user to transfer from the first autonomous vehicle into the second autonomous vehicle; and
program instructions to accept the transfer by the third user for a ride in the second autonomous vehicle after the second user has reached the second travel destination.
